(19) United States
(12) Patent Application Publication
(10) Pub. No.: US 2016/0023867 A1
(43) Pub. Date: Jan. 28, 2016

(54) ANIMAL FEED LOADING, TRANSPORTING AND MIXING SYSTEM

(71) Applicant: Albert Posthumus, Stephenville, TX (US)

(72) Inventor: Albert Posthumus, Stephenville, TX (US)

(21) Appl. No.: 14/341,497

(22) Filed: Jul. 25, 2014

(51) Int. Cl. B66C 17/06; B01F 15/00; B01F 15/02

(52) U.S. Cl. CPC B66C 17/06; B01F 15/0222; B01F 15/00662; B01F 2215/0008

(57) ABSTRACT

According to embodiments disclosed herein, there is provided a system for loading, mixing and transporting feed. The system includes a commodity bay, a crane movable with respect to the commodity bay, and a mixer coupled to the crane. The mixer includes a commodity loader to load commodities into the mixer from the commodity bay. The crane is movable in a first direction to position at least part of the mixer within the commodity bay to load commodities from the commodity bay. The crane is movable in a second direction to transport the mixer away from the commodity bay.

### TECHNICAL FIELD

This disclosure relates to transporting and mixing feed for animals, and in particular, to a system and method for efficiently loading, transporting and mixing feed.

### BACKGROUND OF THE DISCLOSURE

Feed for livestock typically includes a mixture of several different commodities, such as, hay, straw and other types of grain, that when mixed together produce a feed product that is customized to the diet of a group of livestock. The various commodities for a specific feed product are retrieved from bulk commodity locations and then mixed in large, stationary mixers. In practice, commodity transportation vehicles retrieve the required commodities from one or more bulk commodity locations and transport the commodities to the location of the stationary feed mixers. The commodity transportation vehicles, or other commodity loading vehicles such as fork lifts or shovel loaders, then load the commodities into the stationary mixers. When the stationary mixers have fully mixed the commodities, feed transportation vehicles remove the resulting feed from the mixers and transport the feed to long distance feed transportation vehicles, such as feed trailers.

The feed production and transportation process described above requires several manually-operated vehicles, fuel to power the vehicles, and trained workers to operate the vehicles. As such, the process is time consuming and expensive for feed producers. In addition, commodities and/or feed are often lost during loading, transportation and unloading of the commodities and/or feed. The loss of a portion of the commodities and/or feed causes significant losses in profitability for feed producers and is often referred to as “shrinkage.” In addition, because livestock producers rely on a steady supply of feed from the feed production process, maintenance of the components of the above-described process, such as the stationary mixers, must be performed quickly to minimize downtime. Oftentimes, maintenance of the stationary mixers must be performed at the location of the stationary mixer, regardless of the weather conditions or time of day. On-site maintenance and repair of the mixers or other feed production equipment can be dangerous for technicians, especially when other feed production processes are in operation while the technicians perform maintenance.

### SUMMARY

In a first aspect, there is provided a system for loading, mixing and transporting feed. The system includes a commodity bay, a crane movable with respect to the commodity bay, and a mixer coupled to the crane. The mixer includes a commodity loader to load commodities into the mixer from the commodity bay. The crane is movable in a first direction to position at least part of the mixer within the commodity bay to load commodities from the commodity bay. The crane is movable in a second direction to transport the mixer away from the commodity bay.

According to one embodiment, the mixer includes a first set of drive wheels to move the mixer in a first direction toward the commodity bay.

In some embodiments, the mixer includes a second set of drive wheels to move the mixer in a second direction that is perpendicular to the first direction.

In still other embodiments, the first set of drive wheels are perpendicularly oriented to the second set of drive wheels.

In yet another embodiment, the mixer is movable in a vertical direction by the crane.

In other embodiments, the mixer further includes drive wheel, wherein the drive wheel moves the mixer toward the commodity bay when the drive wheel contacts a ground surface.

In still other embodiments, the system includes an electrical connection between the crane and the mixer to supply electricity from the crane to the mixer.

In yet other embodiments, the commodity bay includes a first opening to receive a commodity from a commodity loading vehicle and a second opening to receive the mixer, wherein the first opening is positioned opposite from the second opening.

In still other embodiments, the mixer includes a proximity sensor to sense the proximity of a commodity in the commodity bay to the mixer.

According to a second aspect, there is provided a system for mixing and transporting feed, the system including a commodity bay, a crane movable with respect to the commodity bay, and a mixer coupled to the crane, wherein the mixer receives electrical power from the crane.

According to certain embodiments, the mixer includes a mixing mechanism, forward drive wheels and lateral drive wheels, wherein the mixing mechanism, the forward drive wheels and the lateral drive wheels receive electrical power from the crane.

In other embodiments, the mixer is self-loading.

In still other embodiments, the mixer includes a bucket to load a commodity into the mixer.

In yet other embodiments, the mixer is suspended above a ground surface by the crane.

According to a third aspect, there is provided a method of mixing and transporting feed. The method includes determining a location of a component of a crane, wherein the crane is coupled to a commodity mixer, determining a location of the commodity mixer based on the position of the component of the crane and moving the commodity mixer until the commodity mixer is located at least partially within a commodity bay. The method further includes loading a commodity into the mixer from the commodity bay, mixing the commodity, moving the commodity mixer to an unloading station; and unloading the mixer at the unloading station.

In still other embodiments, the method further includes measuring an amount of the commodity to load into the mixer from the commodity bay.

In other embodiments, the method includes the mixer measuring an amount of a second commodity to load into the mixer from a second commodity bay and loading the measured amount of the second commodity into the mixer.

In yet other embodiments, the method includes loading a plurality of commodities from a plurality of commodity bays into the mixer.

In still other embodiments, moving the commodity mixer until the commodity mixer is located at least partially within a first commodity bay includes elevating the mixer above a floor surface.

In other embodiments, loading a commodity into the mixer from the commodity bay includes lowering the mixer until a drive wheel of the mixer contacts a ground surface.

According to a fourth aspect, there is provided a system for processing livestock feed that includes a building including a plurality of commodity bays and a crane that is movable with respect to the commodity bays. The commodity bays each include a first opening to an exterior of the building for loading commodities into the commodity bay and a second opening positioned opposite from the first opening for unloading commodities from the commodity bay in response to movement of the crane.

In some embodiments, the system includes a mixer coupled to the crane. The mixer is movable with the crane to collect commodities from the second openings of the commodity bays.

Other aspects, features, and advantages will become apparent from the following detailed description when taken in conjunction with the accompanying drawings, which are part of this disclosure and which illustrate, by way of example, principles of the inventions disclosed.

### DESCRIPTION OF THE FIGURES

The accompanying drawings facilitate an understanding of the various embodiments.

FIG. 1 is a plan view of a system for mixing and transporting feed in accordance with this disclosure.

FIG. 2 is a perspective view of the system for mixing and transporting feed in which the mixer is in an elevated position above a floor.

FIG. 3 is a perspective view of the system for mixing and transporting feed in which the mixer is in the floor-contacting position.

FIG. 4 is a plan view of a system for mixing and transporting feed in which the mixer is elevated above a feed transportation vehicle.

FIG. 5 is a plan view of a system for mixing and transporting feed in which the mixer includes a conveyor for loading mixed feed into a feed transportation vehicle.

FIG. 6 is a plan view of a system for mixing and transporting feed in which the mixer is elevated above a feed transportation vehicle.

FIG. 7 is a perspective view of another embodiment of a system for mixing and transporting feed in which the mixer includes forward drive wheels and lateral drive wheels in accordance with this disclosure.

FIG. 8 is a plan view of an embodiment of the system for mixing and transporting feed in which the mixer includes forward drive wheels and lateral drive wheels and the mixer is located above a feed transportation vehicle.

FIG. 9 is a plan view of yet another embodiment of a system for mixing and transporting feed in which the mixer transports the feed directly to a feed lane in accordance with this disclosure.

FIG. 10 is a perspective view of another embodiment of a system for mixing and transporting feed in accordance with this disclosure.

FIG. 11 is a plan view of yet another embodiment of a system for mixing and transporting feed in accordance with this disclosure.

FIG. 12 is a schematic block diagram of a method of mixing and transporting feed in accordance with this disclosure.

### DETAILED DESCRIPTION

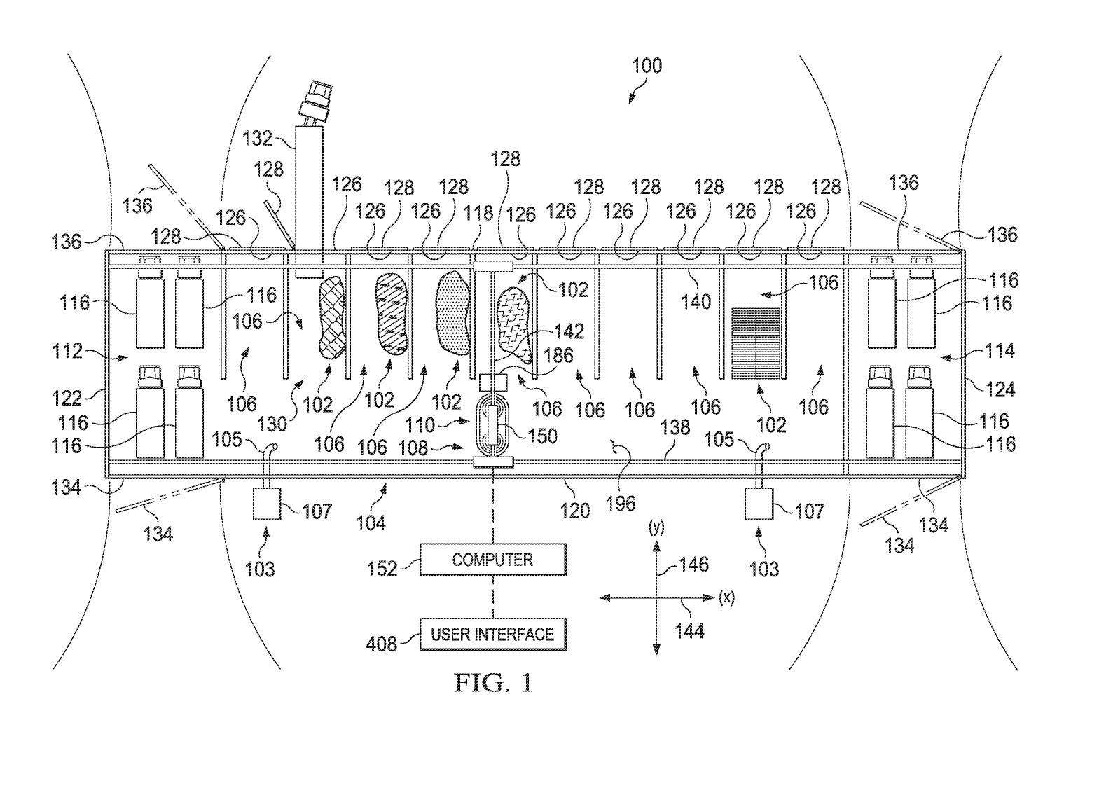

FIGS. 1-6 illustrate an embodiment of a system 100 for loading, mixing and transporting commodities 102 to create feed for livestock or other animals. The system 100 includes a building 104 that includes a plurality of commodity bays 106; a crane system 108 movable with respect to the commodity bays 106; a self-loading mixer 110 coupled to the crane system 108; and loading areas 112 and 114 at which the self-loading mixer 110 deposits feed into feed transportation vehicles 116. As will be described in more detail below, the self-loading mixer 110 is movable on the crane system 108, either manually or automatically, to selectively position the mixer 110 at least partially within the commodity bays 106 to load one or more commodities 102 from the commodity bays 106 into the mixer 110. The mixer 110 measures an amount of each commodity 102 to be included in the mixer 110 based upon a predetermined feed composition and then mixes the commodities 102 as the mixer 110 moves to subsequent commodity bays 106. The system 100 is located inside an enclosed environment (i.e., the building 104) to reduce or eliminate shrinkage that can be caused by high winds and other environmental factors. The movement of the mixer 110 between the commodity bays 106 and the loading/unloading of the mixer 110 can be automatic or semiautomatic to reduce the number of transportation vehicles and operators necessary to produce feed.

Referring now to FIGS. 1-3, the building 104 of the system 100 includes a first wall 118, a second wall 120 opposite from the first wall 118, a third wall 122 and a fourth wall 124 opposite from the third wall 122. A plurality of commodity bays 106 are positioned along the first wall 118 of the building 104 and are configured to hold commodities 102 used to create animal feed, such as, but not limited to, hay, corn silage, straw, cotton seed, ground corn, and milo. The first wall 118 of the building 104 also includes wall openings 126 corresponding to each commodity bay 106 to allow commodity delivery vehicles 132 to deposit commodities within the commodity bays 106. Each wall opening 126 includes a closure mechanism 128 to close the wall opening 126 once the commodity delivery vehicle 132 has unloaded the commodity 102 into the commodity bay 106, thereby enclosing the interior of the building 104 to prevent shrinkage. The commodity bays 106 include a second opening 130 opposite from the wall openings 126 to allow the self-loading mixer 110 to load the commodities 102 from the commodity bays 106 into the mixer 110. Thus, in some embodiments, the commodity delivery vehicles 132 unload commodities 102 into the commodity bays 106 through the wall openings 126 and the mixer 110 loads the commodities 102 through the second openings 130 so that fresh commodities 102 are not placed in front of old commodities 102 in the commodity bays 106.

Referring specifically to the embodiment illustrated in FIG. 1, the building 104 also includes a first loading area 112 and a second loading area 114 to accommodate one or more feed transportation vehicles 116. The loading areas 112 and 114 each include an entry door 134 and an exit door 136 (the entry and exit doors 134 and 136 are shown in the closed position in solid lines and in the open position in dashed lines in FIG. 1) to enclose the building 104 and to reduce shrinkage while the mixer 110 unloads feed from the mixer 110 into the feed transportation vehicles 116.

The building 104 also includes a crane system 108 that is positioned at least partially within the building 104. The crane system 108 includes a first rail 138 and a second rail 140 that are parallel to each other and that extend from the third wall 122 of the building 104 to the fourth wall 124 of the building 104. In other embodiments, the first and second rails 138 and 140 extend less than the full length of the building 104 or extend beyond the full length of the building 104. The first and second rails 138 and 140 are supported in an elevated position above a floor 196 of the building 104.

The crane system 108 also includes a bridge member 142 that extends perpendicularly to the first and second rails 138 and 140 and is movably coupled to the first and second rails 138 and 140. In practice, the bridge member 142 moves in an x-direction 144 on the first and second rails 138 and 140 to allow the mixer 110 to move in the x-direction 144, as described in more detail below. In some embodiments, one or more of the first and second rails 138 and 140 includes a rack (not shown) that mates with a rotatable pinion (not shown) on the bridge member 142. The rotatable pinion includes an encoder or other position tracking device to track the position of the bridge member with respect to the first and second rails 138 and 140. In other embodiments, the bridge member 142 and/or the rails 138 and 140 include other position sensors, such as one or more optical position sensors, to track the position of the bridge member 142 with respect to the first and second rails 138 and 140.

The bridge member 142 of the crane system 108 includes a trolley 150 that is movably coupled to the bridge member 142 such that the trolley 150 is movable in a y-direction 146 on the bridge member 142. The trolley 150 is positionable in the commodity bays 106 and the loading areas 112 and 114 by adjusting the position of the bridge member 142 in the x-direction and the position of the trolley 150 in the y-direction. In some embodiments, the bridge member 142 includes a rack (not shown) that mates to a rotatable pinion (not shown) on the trolley 150. The pinion includes an encoder or other position sensor to track the position of the trolley 150 with respect to the bridge member 142. In other embodiments, the bridge member 142 and/or the trolley 150 include other position sensing mechanisms that are used to track the position of the bridge member 142 and the trolley 150, such as one or more optical sensors. In some embodiments, the position tracking devices of the first and second rails 138 and 140, the bridge member 142 and the trolley 150 send location signals to the computer 152. In some embodiments, the computer 152 tracks the position of the bridge member 142, the trolley 150 and the mixer 110 based on the location signals. In some embodiments, the computer 152 directs movement of the mixer 110 within the building 104 based on the location signals received from the position tracking devices, as will be described in more detail below.

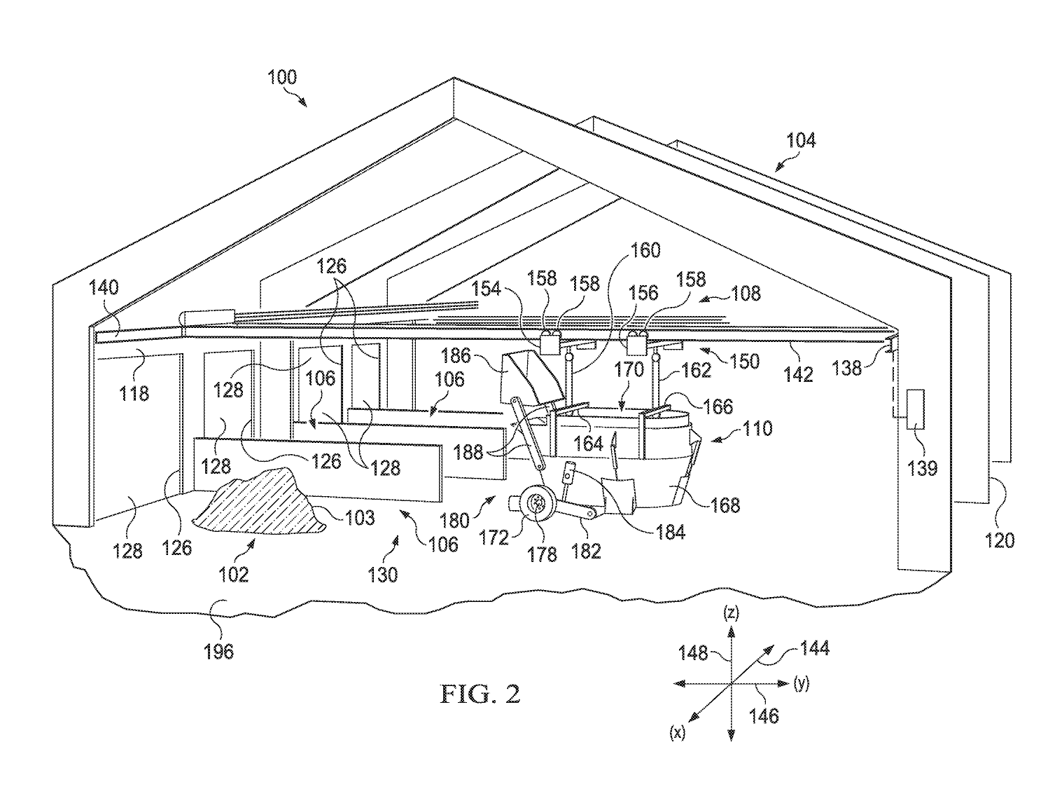

The system 100 also includes a self-loading mixer 110. The self-loading mixer 110 is coupled to the trolley 150 so that the mixer 110 is movable in the y-direction 146 with the trolley 150 and in the x-direction with the bridge member 142 to position the self-loading mixer 110 at least partially within the commodity bays 106 and the loading areas 112 and 114. In some embodiments, the crane system 108 can also move the mixer 110 in a vertical direction, or z-direction 148 (FIGS. 2-6), to suspend the mixer 110 above a floor 196 of the building 104. The self-loading mixer 110 can be any suitable mixer 110 that includes a mechanism for loading commodities into the mixer 110. For example, in some embodiments, the mixer 110 is a TRIOTRAC Self-propelled Mixer Feeder, Model 1700, 2000 or 2400, made by Trioliet Mullos BV of Oldenzaal, Netherlands; a TATOMA Horizontal Mixer, MT Model, made by Tatoma USA of Colcord, Okla., U.S.A.; a Strautmann Verti-Mix 400/500, made by B. Strautmann & Sane GmbH U. Co. KG of Bad Laer, Germany; or a modified version of the foregoing mixers. In some embodiments, the mixer 110 can be easily removed from the crane system 108 and can be replaced with a replacement mixer (not shown). As such, maintenance on the mixer 110 can be performed remotely by transporting the mixer 110 to a location remote from the system 100 while the system 100 utilizes a replacement mixer. As a result, maintenance on the mixer 100 can be performed safely off-site and need not be performed on-site while other feed preparation tasks are performed.

In some embodiments, the position of the mixer 110 within the building 104 is determined at least in part by a computer 152, or multiple computers 152, that monitors the position of the bridge member 142 and the trolley 150, as described above. In some embodiments, the computer 152 also controls the movement of the mixer 110. As such, in some embodiments the computer 152 receives a desired feed composition and controls the movement of the mixer 110 to load the desired amount of the various commodities 102 from the commodity bays 106. For example, in some embodiments a user enters the commodity bays 106 from which commodities 102 are to be loaded and a weight amount for each commodity bay 106. Each commodity bay 106 has a unique name to allow the computer 152 to distinguish the commodity bays 106 from each other. The computer 152 then instructs the mixer 152 and/or the crane system 108 to move the mixer 110 to collect the various commodities 102. In other embodiments, the computer 152 receives manual movement instructions from a user at a remote user interface 408 to move the mixer 110, as will be described in more detail below. In yet other embodiments, a user rides on the mixer 110 and drives the mixer 110 to control the movement of the mixer 110, as will be described below.

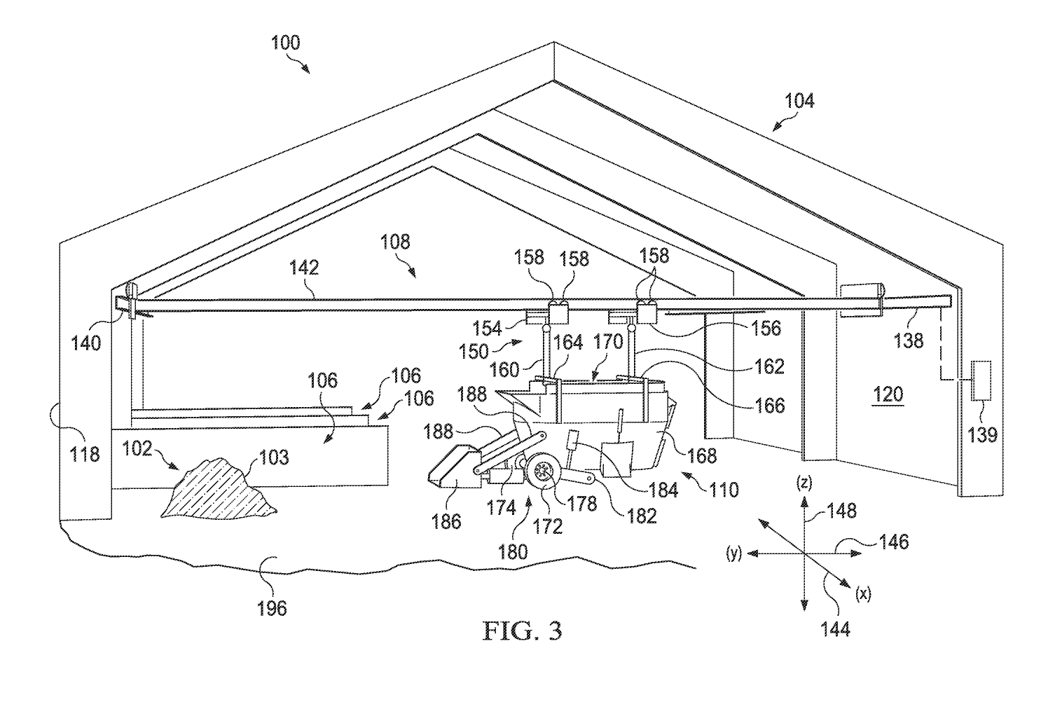

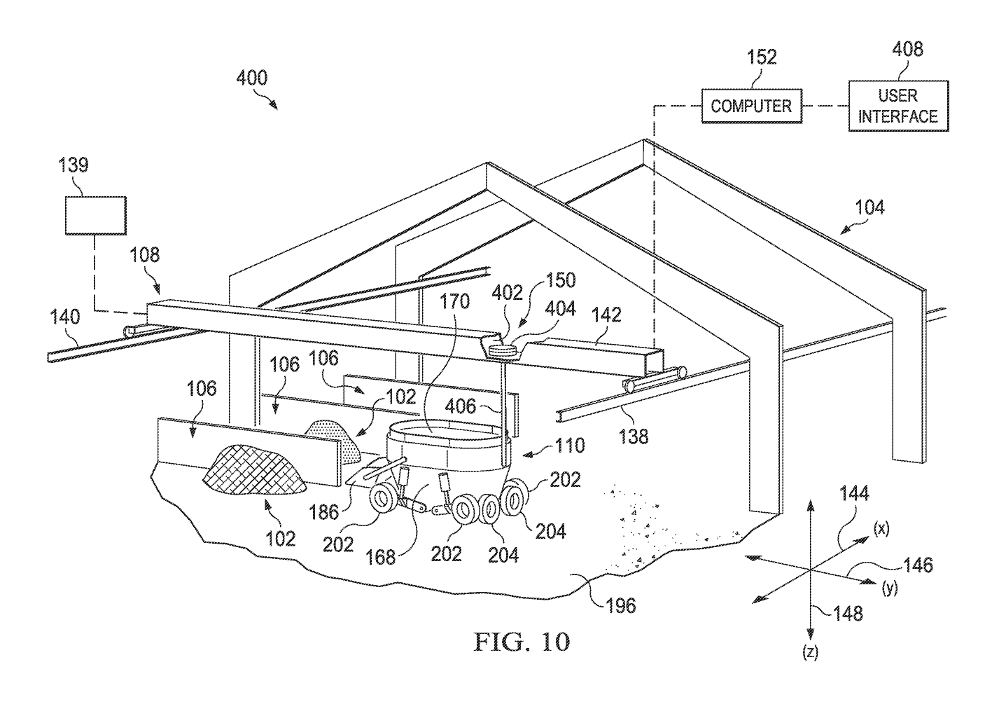

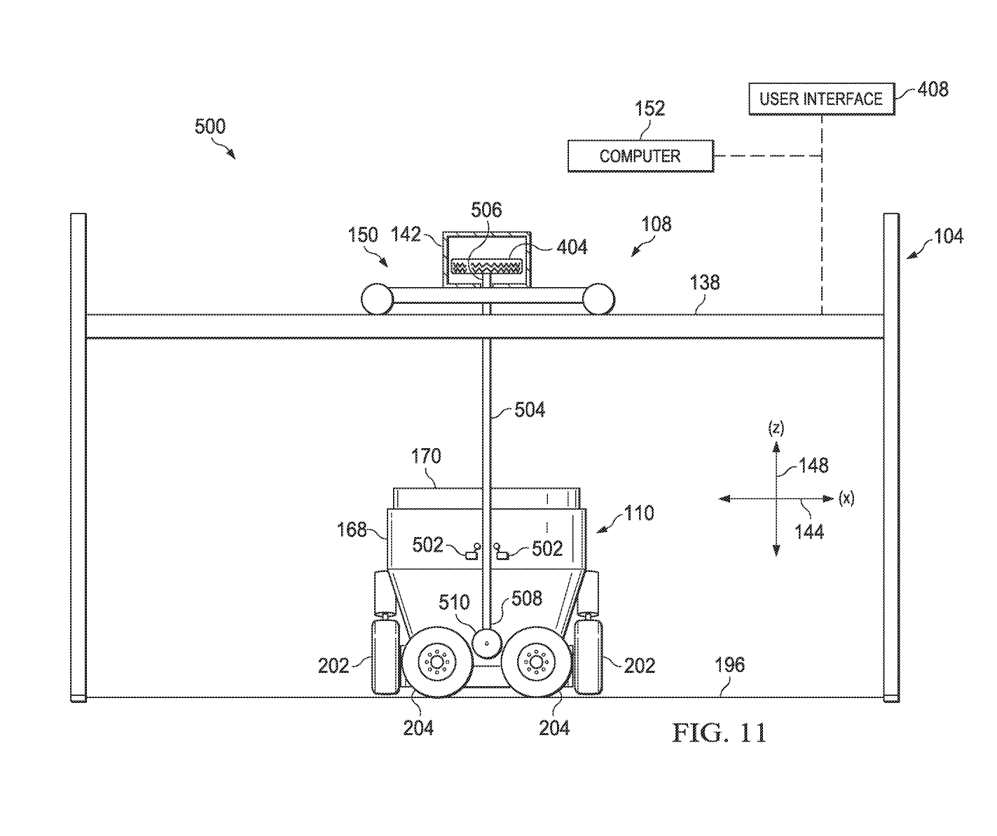

Referring specifically to FIGS. 2 and 3, in some embodiments the trolley 150 of the crane system 108 includes a first hoist member 154 and a second hoist member 156 that are movably coupled to the bridge member 142 by a plurality of rollers 158 to allow the first and second hoist members 154 and 156 to move in the y-direction 146. The first and second hoist members 154 and 156 are coupled to first and second pulley systems 160 and 162 to secure the first and second hoist members 154 and 156 to first and second frame members 164 and 166 of the mixer 110, respectively. The length of the pulley systems 160 and 162 is adjustable to elevate or lower the mixer 110 in the z-direction 148. While the trolley 150 includes first and second hoist members 154 and 156 in the embodiment illustrated in FIGS. 2 and 3, in other embodiments the trolley 150 is any mechanism that is movable on the crane system 108 and provides a coupling between the mixer 10 and the crane system 108. By way of non-limiting example, in the embodiment illustrated in FIGS. 10 and 11, the trolley 150 includes a wheel 404 that is movable on the bridge member 142 in the y-direction 146, as will be discussed in more detail below.

In the embodiment of FIGS. 2 and 3, the mixer 110 includes a body 168 with a mixing opening 170, first and second drive wheels 172 and 174, a bucket 186, and an internal mixing device (not shown). The mixing opening 170 allows for placement of commodities 102 into the internal mixing device of the mixer 110. The first and second drive wheels 172 and 174 couple to an axle 178 that is located adjacent to a loading end 180 of the mixer 110. The axle 178 couples to a cylinder 184 and a linking arm 182 that is pivotally coupled to the mixer 110. In some embodiments, the cylinder 184 includes a pressure sensor (not shown) to sense when the wheels 172 and 174 contact a surface, such as the floor 196 of the building 104. In use, the crane system 108 positions the mixer 110 adjacent to a commodity bay 106 and lowers the mixer 110 so that the first and second wheels 172 and 174 contact the floor 196. When the sensor senses a predetermined force on the first and second wheels 172 and 174, the wheels 172 and 174 engage to move the mixer 110 toward the commodity bay 106 to load the mixer 110, as will be described in more detail below.

The bucket 186 of the self-loading mixer 110 is pivotally mounted to the loading end 180 of the mixer 110 and is configured to load commodities 102 into the mixing opening 170 of the mixer 110. The bucket 186 is pivotally coupled to the mixer 110 by arms 188 so that the bucket 186 can be raised and lowered with respect to the body 168 of the mixer 110. While a bucket 186 is shown in the embodiments of FIGS. 2 and 3, any suitable mechanism may be used to load commodities 102 into the mixer 110.

In some embodiments, the mixer 110 is powered by a combustible fuel, such as gasoline, while in other embodiments the mixer 110 is electrically powered. In some embodiments, the electrical power is supplied to the mixer 110 by way of the crane system 108. For example, in some embodiments, the first and/or second rails 138 and 140 are coupled to an electricity source 139 and the first and/or second rails 138 and 140 transfer electricity from the electricity source 139 to the bridge member 142 by way of an electrical connection (not shown), such as a sliding electrical contact. Similarly, in some embodiments, the bridge member 142 transfers electricity to the trolley 150 at an electrical connection (not shown), such as a sliding electrical contact. In some embodiments, the trolley 150 is electrically coupled to the mixer 110 to supply electrical power to the drive wheels 172 and 174, the arm 188, the mixing mechanism (not shown) or other elements of the mixer 110. In other embodiments, electricity is supplied to the mixer 110 via the crane system 108 in other manners, such as, for example, by a power cable (not shown) mounted to the first or second rail 138 or 140, the bridge member 142 and the trolley 150 in a festoon-style mounting. In some embodiments, the mixer 110 is powered by both fuel and electrical power.

As discussed above, in some embodiments a computer 152 controls the movement of the mixer 110. In some embodiments, a user enters a feed composition, including an amount and/or weight of one or more commodities 102, into the computer 152. The computer 152 determines the location of the mixer 110 based at least in part on the location of the trolley 150 and then instructs the crane system 108 to move the mixer 110 to a position adjacent to a commodity bay 106 containing a first commodity 103 to be loaded into the mixer 110. In some embodiments, the crane system 108 elevates the mixer 110 above the floor 196 and then moves the mixer 110 to the position adjacent to the desired commodity bay 106 by moving the bridge member 142 and the trolley 150.

Referring now to FIG. 3, once the crane system 108 has positioned the mixer 110 adjacent to the desired commodity bay 106, the crane system 108 lowers the mixer 110 so that the drive wheels 172 and 174 contact the floor 196 and lowers the bucket 186. When the drive wheels 172 and 174 contact the floor 196, the drive wheels 172 and 174 engage and move the mixer 110 toward the commodity bay 106 (i.e., in the y-direction 146). In some embodiments, the crane system 108 also applies a force to the mixer 110 by moving the trolley 150 in the direction of the commodity bay 106. The bucket 186 of the mixer 110 contacts the first commodity 103 in the commodity bay 106 and loads an amount of the first commodity 103 into the bucket 186. In some embodiments, the mixer 110 includes a proximity sensor (not shown) to sense the proximity of the first commodity 103 to the bucket 186 of the mixer 110. In some embodiments, the bucket 186 includes a weight sensor to sense the weight of the first commodity 103 in the bucket 186. The bucket 186 collects a predetermined amount of the first commodity 103 and loads the first commodity 103 into the mixer 110 through the mixing opening 170.

The mixer 110 then moves away from the commodity bay 106 containing the first commodity 103. In some embodiments, the drive wheels 172 and 174 move in a reverse direction (i.e., away from the commodity bay 106 in the y-direction 146) to move the mixer 110 away from the commodity bay 106. In other embodiments, the crane system 108 elevates the mixer 110 above the floor 196 and moves the mixer 110 away from the commodity bay 106. The crane system 108 then moves the mixer 110 to another commodity bay 106 containing another commodity 102 to be included in the resulting feed. As described above, the crane system 108 then lowers the mixer 110 until the drive wheels 172 and 174 contact the ground and the crane system 108 and the drive wheels 172 and 174 move the mixer 110 towards the second commodity 102. The bucket 186 then loads a predetermined amount of another commodity 102 into the mixer 110. The mixing mechanism (not shown) of the mixer 110 engages to mix the first commodity 102 with the other commodity 102.

The crane system 108 then moves the mixer 110 to subsequent commodity bays 106 to load subsequent commodities 102 into the mixer 110. In some embodiments, the crane system 108 also loads liquid commodities 107 into the mixer 110 at a liquid commodity loading station 103 by positioning the mixer 110 below a liquid commodity nozzle 105 at the liquid commodity loading station 103. The mixer 110 mixes the commodities 102 and 107 as the crane system 108 moves the mixer 110 with respect to the commodity bays 106. Because the commodity bays 106 and the mixer 110 are located within the building 104, shrinkage is minimized while the mixer loads and mixes the commodities 102.

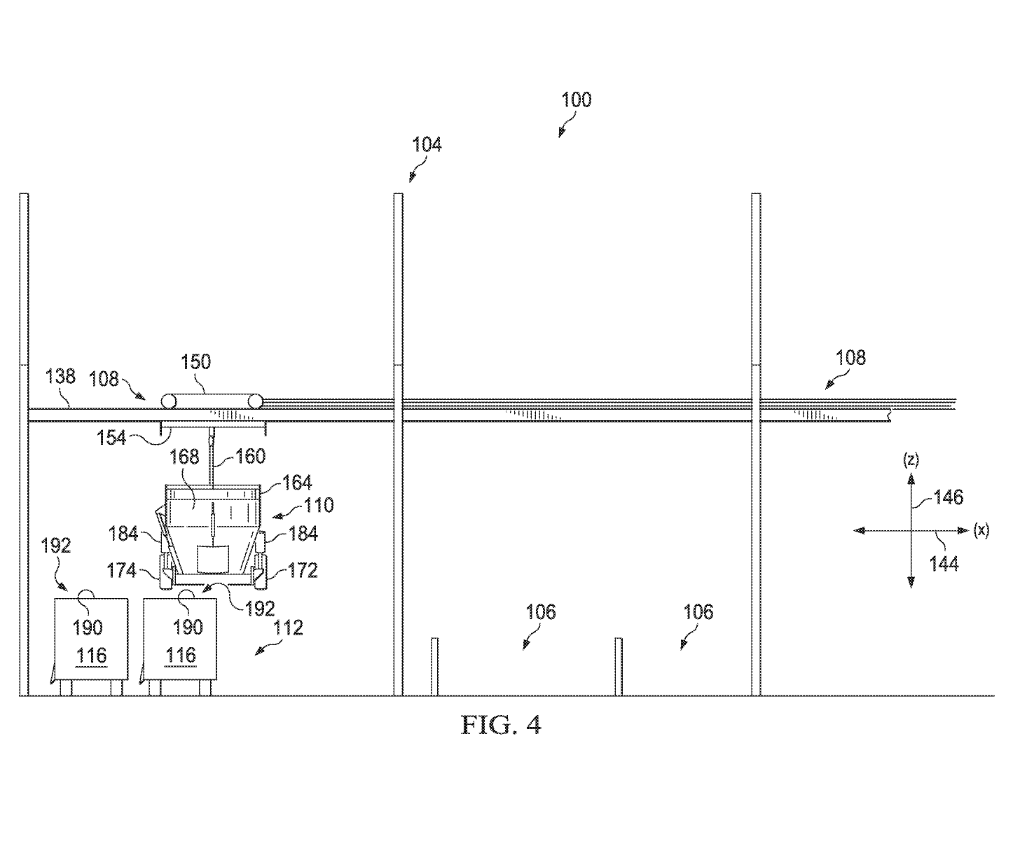

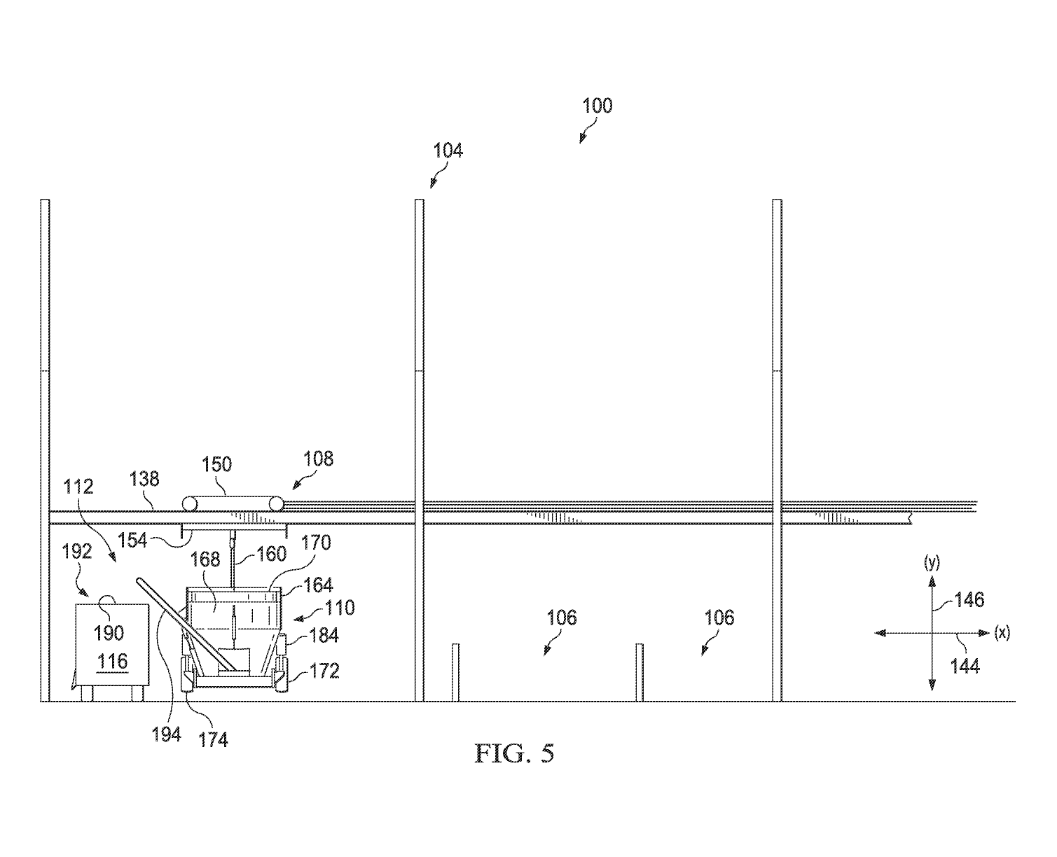

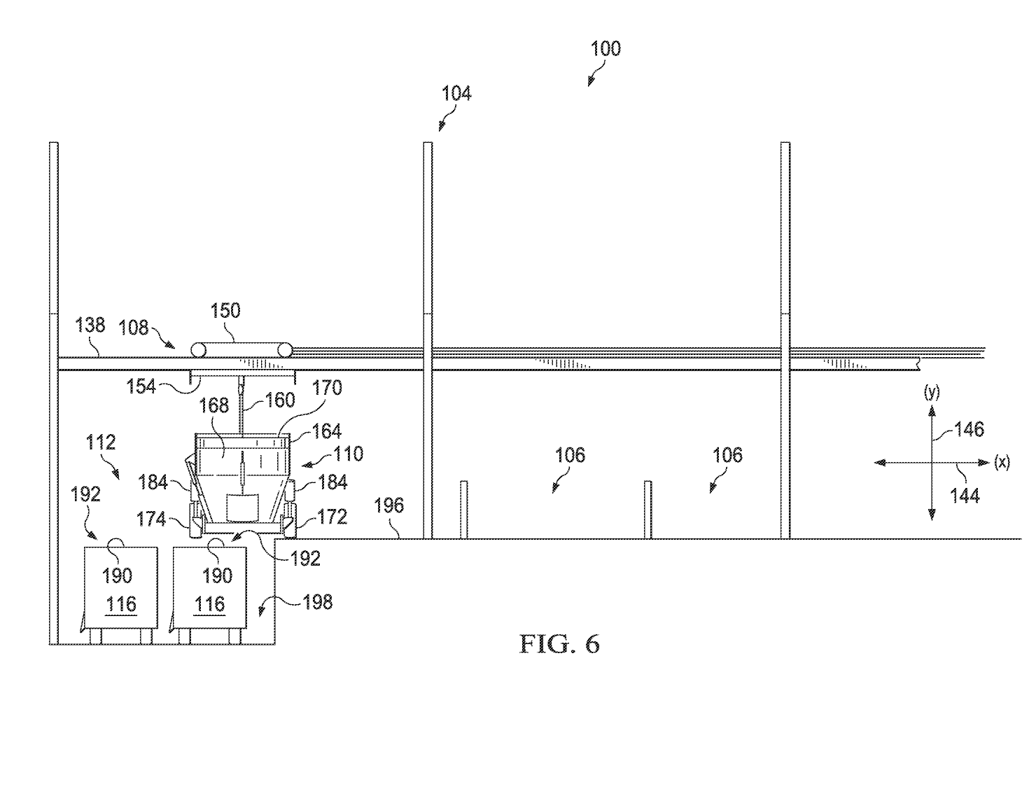

The crane system 108 then moves the mixer 110 to either the first or the second loading area 112 or 114 (FIG. 1) to load the mixed feed into a feed transportation vehicle 116. The mixer 110 can load feed into the feed transportation vehicle 116 in any suitable manner. In the embodiment illustrated in FIG. 4, for example, the crane system 108 elevates the mixer 110 above a feed transportation vehicle 116 so that the mixer 110 deposits the feed from the mixer 110 into an opening 190 in a top end 192 of the feed transportation vehicle 116. In the embodiment illustrated in FIG. 5, the mixer 110 includes a conveyor 194 to move the feed from the mixer 110 to the opening 190 in the top end 192 of the feed transportation vehicle 116. In the embodiment illustrated in FIG. 6, the crane system 108 lifts the mixer 110 over a recessed loading area 198 so that the mixer 110 is located over the opening 190 in the top end 192 of the feed transportation vehicle 116. The feed transportation vehicles 116 transport the feed to feeding locations where the feed is consumed by livestock.

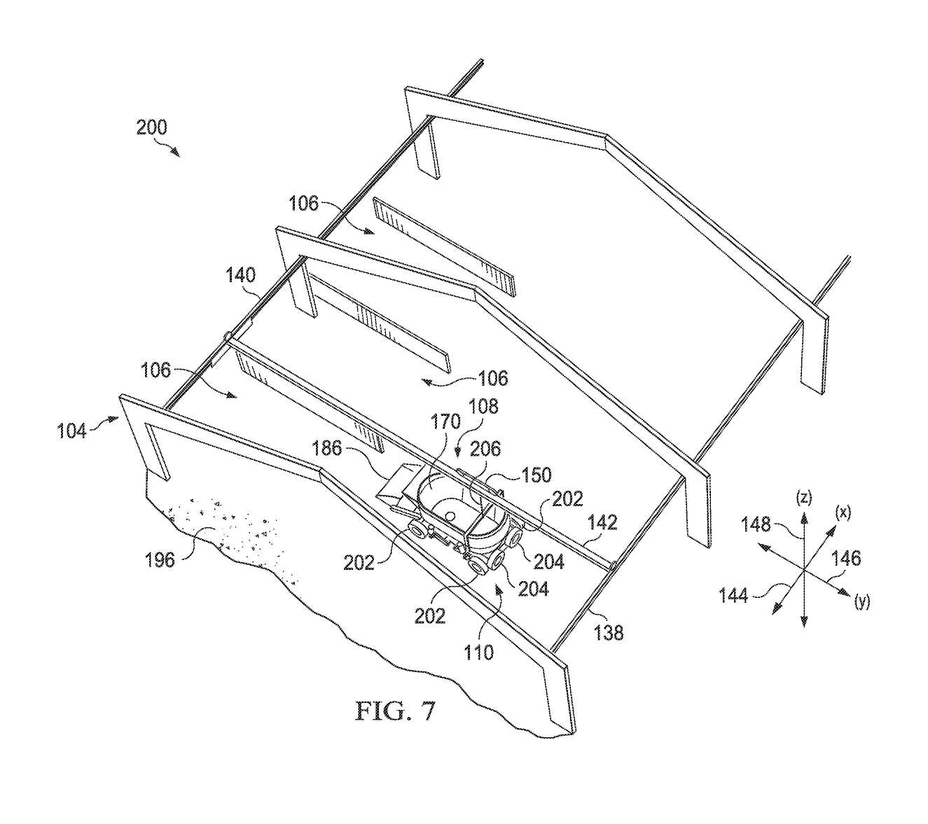

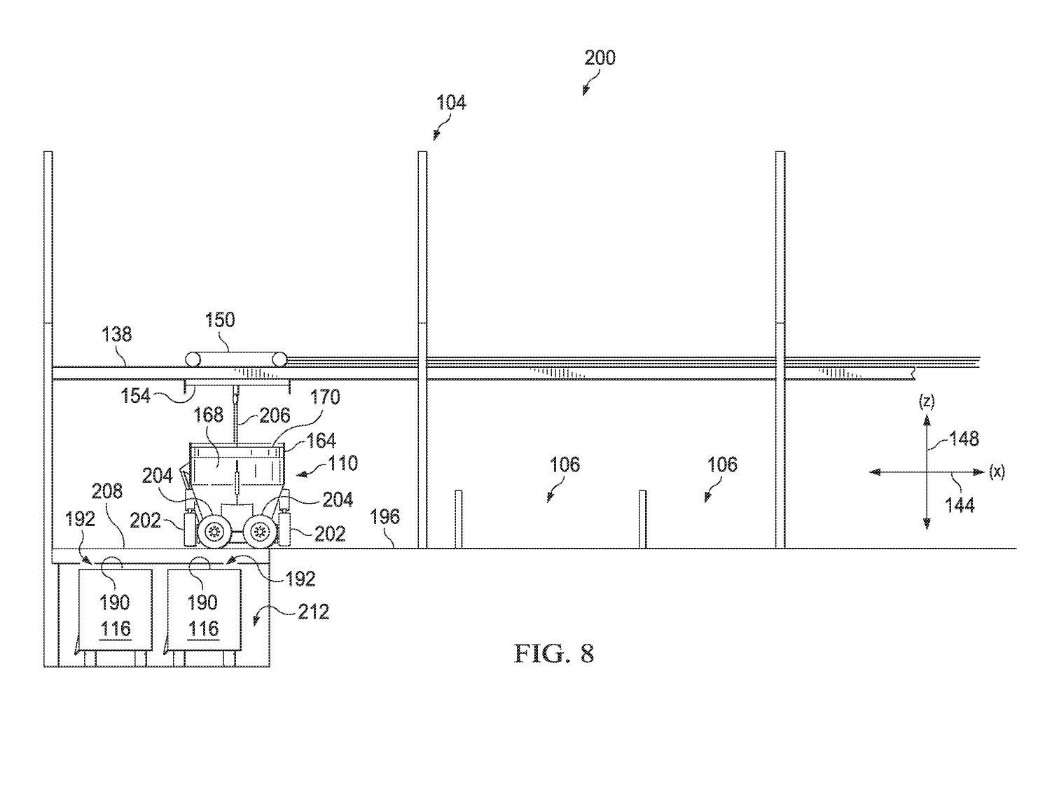

FIGS. 7 and 8 illustrate another embodiment of a system 200 for mixing and transporting feed. In the embodiment illustrated in FIGS. 7 and 8, the mixer 110 includes four forward drive wheels 202 and four lateral drive wheels 204 that are positioned perpendicularly to the forward drive wheels 202. To accommodate forward movement (i.e., movement in the y-direction), the mixer 110 lowers the forward drive wheels 202 to contact the floor 196 and raises the lateral derive wheels 204 above the floor 196. To accommodate lateral movement (i.e., movement in the x-direction), the mixer 110 lowers the lateral drive wheels 204 to contact the floor 196 and raises the forward drive wheels 202 above the floor 196. Thus, the mixer 110 is movable in the x-direction 144 and the y-direction 146 without being elevated by the crane system 108. Any suitable mechanism may be used to raise and lower the wheels 202 and 204, such as one or more hydraulic pistons. In some embodiments, the forward drive wheels 202 are fixed in place on the mixer 110 and only the lateral drive wheels 204 are raised and lowered. In other embodiments, the lateral drive wheels 204 are fixed in place on the mixer 110 and only the forward drive wheels 202 are raised and lowered. In other embodiments, both the forward drive wheels 202 and the lateral drive wheels 204 are raised and lowered on the mixer 110.

In the embodiment illustrated in FIGS. 7 and 8, a connector 206 couples the mixer 110 to the trolley 150. Because the mixer 110 is movable in the x and y directions 144 and 146 on the floor 196 (i.e., the crane system 108 need not elevate the mixer 110 to move the mixer 110 in the x- and y-directions 144 and 146), the connector 206 is a light duty connector designed to couple the mixer 110 to a passive crane system 108 so that the trolley 150 and the bridge member 142 simply follow the movement of the mixer 110 as the mixer 110 moves on the floor 196. In other words, when the mixer 110 moves due to the contact between the forward drive wheels 202 or the lateral drive wheels 204 and the floor 196, the trolley 150 simply follows the movement of the mixer 110 due to the movement of the connector 206. As such, the trolley 150 and the crane system 108 need not be powered to move the mixer 110 and need not be structurally able to hold the weight of the mixer 110 and may thus be a lighter weight and lower strength construction.

Referring now specifically to FIG. 8, the mixer 110 is movable on the lateral drive wheels 204 to position the mixer 110 above the loading area 212. In some embodiments, the mixer 110 is supported on a platform 208 above the recessed loading area 212 such that the mixer 110 is located above the feed transportation vehicles 116 and can deposit feed into the openings 190 of the feed transportation vehicles 116. The mixer 110 also can deposit feed into the feed transportation vehicles 116 in other suitable manners in other embodiments, such as, but not limited to, the feed loading embodiments illustrated in FIGS. 4-6.

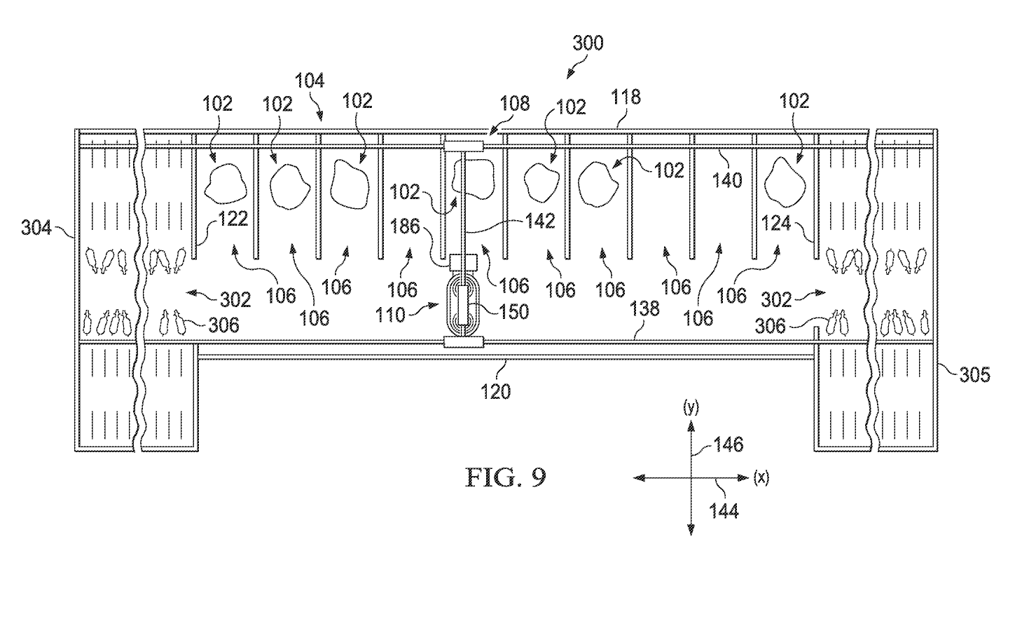

FIG. 9 is a plan view of another embodiment of a system 300 for mixing and transporting feed in which the mixer 110 transports the feed directly to a feed lane 302. As illustrated in FIG. 9, the feed lanes 302 are positioned adjacent to the third and fourth walls 112 and 124 of the building 104. The first and second rails 138 and 140 of the crane system 108 extend to the outer walls 304 and 305 of the feeding lanes 302 to allow the mixer 110 to travel along the feeding lanes 302. As such, the mixer 110 is positionable in the feed lanes 302 to distribute feed directly to animals 306 located adjacent to the feed lanes 302.

FIG. 10 illustrates another embodiment of a system 400 for mixing and transporting feed. In the embodiment illustrated in FIG. 10, the crane system 108 includes a passive crane system 108 that includes a bridge member 142 with a channel 402. The crane system 108 also includes a trolley 150 that includes a wheel 404 that is movable within the channel 402. The mixer 110 is a manually-operated, self-propelled mixer 110 that is operated by a user (not shown) that is seated on the mixer 110. The mixer 110 includes a rigid bar 406 that couples the mixer 110 to the wheel 404 so that the wheel 404, the trolley 150 and the bridge member 142 move with the mixer 110. Thus, the crane system 108 need not elevate and/or move the mixer 110. Instead, the crane system 108 simply follows the movement of the mixer 110. In some embodiments, the self-propelled mixer 110 receives electrical power through the trolley 150. In some embodiments, the user manually operates the mixer 110 to load commodities 102 into the mixer 110. The mixer 110 mixes the commodities 102 as the user drives the mixer 110 within the building 104 to load additional commodities 102. As the user drives the mixer 110 within the building 104, the trolley 150 and the bridge member 142 follow the mixer 110 due to the connection between the rigid bar 406 and the wheel 404. Electricity is supplied from an electricity source 139 to the mixer 110 through the rigid bar 406 as the mixer 110 is operated by the user.

In other embodiments the self-propelled mixer 110 is controlled remotely via a remote user interface 408 that is coupled to the self-propelled mixer 110 wirelessly or through a wired connection (not shown). For example, in some embodiments, the remote user interface 408 is coupled to the mixer 110 via a wired connection that forms part of the crane system 108 and the rigid bar 406. In use, a user interacts with the remote user interface 408 to control the movement of the self-propelled mixer 110. In some embodiments, for example, the user manually controls the position of the mixer 110 via the remote user interface 408. In other embodiments, the user enters information regarding the amounts of each commodity 102 from the various commodity bays 106 that are to be included in the mixer 110 at the user interface 408. In some embodiments, the user interface 408 automatically controls the movement of the mixer 110 based on the user input received at the user interface 408. As described above, the self-propelled mixer 110 loads commodities 102 from the commodity bays 106 into the mixer 110 and mixes the commodities 102 as the mixer 110 moves within the building 104. As the self-propelled mixer 110 moves within the building 104, the trolley 150 and the bridge member 142 of the passive crane system 108 follow the mixer 110 due to the connection between the rigid bar 406 and the wheel 404. Thus, the position of the mixer 110 is tracked by the trolley 150 and the bridge member 142 as the mixer 110 moves within the building 104. In some embodiment, position sensing equipment (not shown) on the trolley 150 and/or the bridge member 142 transmit position signals to a computer 152 coupled to the user interface 408, as described above.

FIG. 11 illustrates yet another embodiment of a system 500 for mixing and transporting feed. The system 500 includes a crane system 108 that includes a trolley 150 that moves within the building 104. In some embodiments, a computer 152 automatically moves the trolley 150 and the bridge member 142 within the building 104, while in other embodiments a user at a user interface 408 controls the movement of the trolley 150 via the user interface 408. The trolley 150 includes a wheel 404 that is coupled to a first end 506 of a pivoting bar 504. A second end 508 of the pivoting bar 504 is coupled to the mixer 110 at a pivot point 510. In practice, the computer 152 or user interface 408 sends instructions to move the trolley 150 and the bridge member 142 within the building 104. As the trolley 150 and the bridge member 142 move, the first end 506 of the pivoting bar 504 moves with the trolley 150 and the second end 508 of the pivoting bar 504 pivots on the pivot point 510. As the pivoting bar 504 pivots, the pivoting bar 504 comes into contact with one or more switches 502 located adjacent to the pivoting bar 504 on the mixer 110. When a particular switch 502 is actuated by the pivoting bar 504, the mixer 110 moves in a specified direction so that the mixer 110 moves with the trolley 150 and the bridge member 142. In other embodiments, the mixer 110 includes one or more sensors (not shown) positioned around the pivoting bar 504 in addition to, or in place of, the switches 502 to sense movement of the pivoting bar 504.

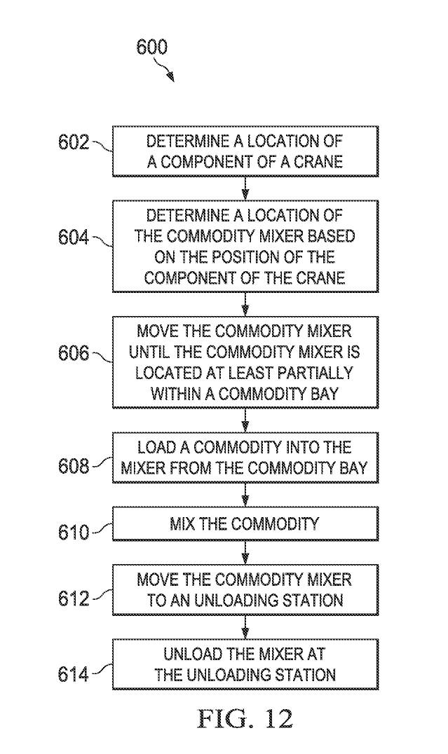

FIG. 12 illustrates an embodiment of a method 600 of mixing and transporting feed using a self-loading mixer 110. The method 600 begins and a location of a component of the crane system 108, such as the trolley 150 or the bridge member 142, is determined as shown at block 602. A location of the mixer 110 is then determined based on the position of the component of the crane system 108, as shown at block 604. The mixer 110 moves until the mixer 110 is located at least partially within a commodity bay 106, as shown at block 606. The mixer 110 then loads a commodity 102 from the commodity bay 106 into the mixer 110, as shown at block 608. The mixer 110 then mixes the commodity 102, as shown at block 610. The mixer 110 then moves to other commodity bays 106 to load other commodities 102 into the mixer 110. The commodities 102 are mixed in the mixer 110 to create a finished feed product. The mixer 110 then moves to an unloading station, such as the loading areas 112 and 114, as shown at block 612. The mixer 110 then unloads feed from the mixer 110 at the unloading station, as shown at block 614.

The foregoing describes only some embodiments of the invention(s), and alterations, modifications, additions and/or changes can be made thereto without departing from the scope and spirit of the disclosed embodiments, the embodiments being illustrative and not restrictive. For example, in other embodiments, other types of cranes systems 108 are used to determine the location of the mixer 110, to move the mixer 110 and/or to supply electrical power to the mixer 110. In addition, while certain embodiments of the mixer 110 have been described herein, other embodiments are included within the scope of this disclosure. For example, existing self-loading mixers can be modified as needed to include a loading mechanism, lateral drive wheels 204, components capable of computer-controlled movement, or other features. It is also anticipated that self-loading mixers will be developed in the future that can be incorporated in the systems described herein. In addition, while a single crane system 108 and a single mixer 110 are describe above, in some embodiments the systems 100, 200, 300, 400 and 500 include more than one mixer 110 or more than one crane system 108. For example, in some embodiments a single crane system 108 includes more than one mixer 110. In some embodiments, for example, the crane system 108 includes two trollies 150 and each trolley 150 is coupled to a separate mixer 110. In other embodiments, the systems 100, 200, 300, 400 and 500 include a first crane system 108 with a first mixer 110 and a second crane system 108 with a second mixer 110. In some embodiments, the first crane system 108 is independent of the second crane system 108 so that the first mixer 110 moves independently of the second mixer 110. In other embodiments, any number of crane systems 108 and mixers 110 can be included in a single system 100, 200, 300, 400 and 500.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Furthermore, invention(s) have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A system for loading, mixing and transporting feed, comprising:
a commodity bay;
a crane movable with respect to the commodity bay; and
a mixer coupled to the crane, wherein the mixer includes a commodity loader to load commodities into the mixer from the commodity bay, wherein the crane is movable in a first direction to position at least part of the mixer within the commodity bay to load commodities from the commodity bay and wherein the crane is movable in a second direction to transport the mixer away from the commodity bay.

2. The system of claim 1, wherein the mixer comprises a first set of drive wheels to move the mixer in a first direction toward the commodity bay.

3. The system of claim 2, wherein the mixer comprises a second set of drive wheels to move the mixer in a second direction that is perpendicular to the first direction.

4. The system of claim 3, wherein the first set of drive wheels are perpendicularly oriented to the second set of drive wheels.

5. The system of claim 1, wherein the mixer is movable in a vertical direction by the crane.

6. The system of claim 5, wherein the mixer further comprises a drive wheel, wherein the drive wheel moves the mixer toward the commodity bay when the drive wheel contacts a ground surface.

7. The system of claim 1, further comprising an electrical connection between the crane and the mixer to supply electricity from the crane to the mixer.

8. The system of claim 1, wherein the commodity bay comprises a first opening to receive a commodity from a commodity loading vehicle and a second opening to receive the mixer, wherein the first opening is positioned opposite from the second opening.

9. The system of claim 1, wherein the mixer comprises a proximity sensor to sense the proximity of a commodity in the commodity bay to the mixer.

10. A system for mixing and transporting feed, comprising:
a commodity bay;
a crane movable with respect to the commodity bay; and
a mixer coupled to the crane, wherein the mixer receives electrical power from the crane.

11. The system of claim 10, wherein the mixer comprises a mixing mechanism, forward drive wheels and lateral drive wheels, wherein the mixing mechanism, the forward drive wheels and the lateral drive wheels receive electrical power from the crane.

12. The system of claim 10, wherein the mixer is self-loading.

13. The system of claim 12, wherein the mixer comprises a bucket to load a commodity into the mixer.

14. The system of claim 10, wherein the mixer is suspended above a ground surface by the crane.

15. A method of mixing and transporting feed, comprising:
determining a location of a component of a crane, wherein the crane is coupled to a commodity mixer;
determining a location of the commodity mixer based on the position of the component of the crane;
moving the commodity mixer until the commodity mixer is located at least partially within a commodity bay;
loading a commodity into the mixer from the commodity bay;
mixing the commodity;
moving the commodity mixer to an unloading station; and
unloading the mixer at the unloading station.

16. The method of claim 15, further comprising the mixer measuring an amount of the commodity to load into the mixer from the commodity bay.

17. The method of claim 15, further comprising the mixer measuring an amount of a second commodity to load into the mixer from a second commodity bay and loading the measured amount of the second commodity into the mixer.

18. The method of claim 15, further comprising loading a plurality of commodities from a plurality of commodity bays into the mixer.

19. The method of claim 15, wherein moving the commodity mixer until the commodity mixer is located at least partially within a first commodity bay comprises elevating the mixer above a floor surface.

20. The method of claim 19, wherein loading a commodity into the mixer from the commodity bay comprises lowering the mixer until a drive wheel of the mixer contacts a ground surface.

21. A system for processing livestock feed, comprising:
a building including a plurality of commodity bays; and
a crane located within the building and movable with respect to the commodity bays;
wherein the plurality of commodity bays each include a first opening to an exterior of the building for loading commodities into the commodity bay and a second opening positioned opposite from the first opening for unloading commodities from the commodity bay in response to movement of the crane.

22. The system of claim 21, further comprising a mixer coupled to the crane, wherein the mixer is movable with the crane to collect commodities from the second openings of the commodity bays.
